(19) United States
(12) Patent Application Publication
(10) Pub. No.: US 2005/0084027 A1
(43) Pub. Date: Apr. 21, 2005

(54) Method for multiple broadcasting in a mobile radiocommunication system

(76) Inventor: Pascal Agin, Sucy En Brie (FR)

Correspondence Address: SUGHRUE MION, PLLC, 2100 PENNSYLVANIA AVENUE, N.W., SUITE 800, WASHINGTON, DC, 20037, US

(21) Appl. No.: 10/504,082

(22) PCT Filed: Feb. 11, 2003
(86) PCT No.: PCT/FR03/00419

(30) Foreign Application Priority Data
Feb. 11, 2002 (FR) 02/01623

(51) Int. Cl. H04L 1/02

(52) U.S. Cl. 375/267

(57) ABSTRACT

The invention relates to a method for improving the performance of a mobile radiocommunication system with N broadcasting antennae (where N>1) in which different modes of multiple broadcast antennae are possible, including at least one mode assigned to n broadcast antennae (where 1=n<N). Said method comprises a selection stage for n broadcast antennae amongst N for transmission in one mode to n broadcast antennae.

The present invention relates generally to mobile radio systems.

The present invention is applicable in particular to code division multiple access (CDMA) systems.

Thus the present invention is applicable in particular to third generation systems such as the Universal Mobile Telecommunication System (UMTS) in particular.

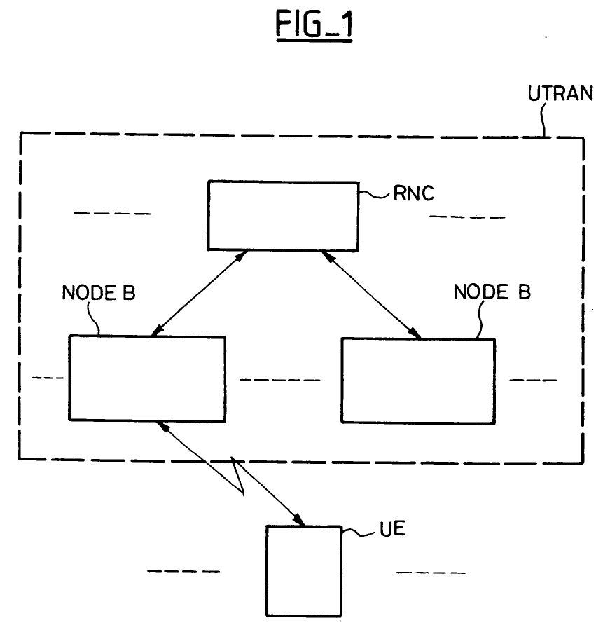

As shown in FIG. 1, a mobile radio system generally comprises the following entities: mobile stations (also known as user equipments (UE) in the UMTS), base stations (also known as Nodes B in the UMTS), and base station controllers (also known as radio network controllers (RNC) in the UMTS). The combination of the Nodes B and the RNCs is called the UMTS terrestrial radio access network (UTRAN), or more generally the radio access network (RAN).

These systems are generally covered by standards and for more information the corresponding standards published by the corresponding standardization organizations may be consulted.

In these systems, one objective is generally to improve performance, in particular to increase capacity and/or to improve quality of service.

Antenna diversity techniques intended in particular to combat the phenomena known as fast fading on the radio channel are routinely used in these systems. A distinction is usually made between receive antenna diversity techniques and transmit antenna diversity techniques.

Receive antenna diversity techniques use a plurality of receive antennas. The signals received at the various antennas may then be processed to optimize the quality of the received data estimate. These techniques are routinely used in base stations to improve transmission performance in the uplink direction (the transmission direction from the mobile stations to the base stations). However, they are difficult to use in the downlink direction (the transmission direction from the base stations to the mobile stations) because equipping mobile stations with a plurality of receive antennas would make them too costly and/or too complex. This is why transmit antenna diversity techniques are used instead to improve downlink performance (in particular to increase downlink capacity).

Transmit antenna diversity techniques use a plurality of transmit antennas. A distinction is generally made between:
open loop transmit antenna diversity techniques, which require no feedback of information from the receiver, and
closed loop transmit antenna diversity techniques, which require feedback from the receiver.

More than one transmit antenna diversity technique may be used in the same system. The example of the UMTS is considered more particularly hereinafter, although the invention is not limited to that particular example. In the UMTS, in a frequency domain duplex (FDD) mode, the following techniques have been standardized for two transmit antennas:
the space time transmit diversity (STTD) technique, in which time coding and space coding enable the receiver to demodulate the data without additional complexity compared to the no-diversity situation; this technique may be used for all physical downlink channels except the synchronization channels;
the time switch transmit diversity (TSTD) technique, which consists in transmitting the signal at each antenna in turn in each time slot; this technique is used only for downlink synchronization channels; and
the closed loop transmit antenna diversity technique, in which the mobile station periodically transmits to the base station control information (also known as weight information) for adjusting the phase and/or the amplitude of the signals transmitted at the various antennas in order to optimize receive performance; in this case two modes are available, namely a first mode (called mode 1) in which the relative phase of the signals transmitted at the two antennas is adjusted and a second mode (called mode 2) in which the relative phase and amplitude of the signals transmitted at the two antennas are adjusted; this technique may be used for dedicated physical channels (DPCH) or for physical downlink shared channels (PDSCH).

It is also possible not to use any transmit antenna diversity technique at all. In the UMTS, four transmit diversity modes may be used to transmit dedicated physical channels (DPCH) in the downlink direction:
no-diversity mode,
STTD mode,
closed loop mode 1,
closed loop mode 2.

The transmit diversity mode is selected independently for each mobile station. Thus in each cell there may be mobile stations (known as no-diversity mobile stations) for which no transmit antenna diversity technique is used and mobile stations (known as diversity mobile stations) for which a transmit antenna diversity technique is used, which may be the STTD technique or one of the two possible closed loop modes.

The diversity mode to be used for each mobile station is generally selected by the base station controller (or RNC), generally as a function of the capabilities of the base station (or Node B) and the mobile station (or UE) and as a function of radio criteria (for example, the STTD mode generally achieves better performance than either of the two closed loop modes when the mobile station is in a soft handover transmission configuration (also known as a macrodiversity transmission configuration), in which it is connected to a plurality of base stations simultaneously).

Also, in the above systems, a particular physical channel called the common pilot channel is broadcast by each base station, in particular to enable mobile stations to estimate the radio channel before estimating data received via the radio channel. In the UMTS, this common pilot channel is also known as the primary common pilot channel (P-CPICH).

To allow transmit antenna diversity in a cell, the P-CPICH must be transmitted at each of the two transmit antennas to enable estimation of the radio channel connecting each of the two transmit antennas to the receive antenna.

In this case:
the P-CPICH is transmitted at a first antenna (usually called the no-diversity antenna) in exactly the same way as when transmit antenna diversity is not used in the cell (although possibly at a lower power), and
the P-CPICH is also transmitted at a second antenna (usually called the diversity antenna) for use by all mobile stations with diversity (i.e. using the STTD technique or one of the two possible closed loop modes).

To enable mobile stations to distinguish the P-CPICH transmitted at the two transmit antennas, different bit patterns are used (in other words, the sequence of bits transmitted on the two channels is not the same for both antennas). See for example the technical specification 3GPP TS 25.211, V3.8.0 section 5.3.3.1.

The dedicated physical channel that transports the traffic information that is useful for a mobile station, namely the dedicated physical channel (DPCH), is transmitted to the mobile station either by the no-diversity antenna in the case of a no-diversity mobile station or by both antennas (diversity and no-diversity) otherwise.

The applicant has realized that this gives rise to a problem, which may be stated in the following terms.

Since there can be diversity mobile stations and no-diversity mobile stations in a cell, a much higher power may be transmitted by the no-diversity antenna than the diversity antenna (the difference being down to the mobile stations that do not use any diversity technique).

A configuration of this kind is not at all optimized in terms of performance. In one of the usual implementations there is a power amplifier (PA) for each antenna, as each antenna transmits a different signal. Each power amplifier amplifies the whole of the signal transmitted at its antenna (including all the common channels and physical channels in the downlink direction dedicated to the various users). To avoid distortion of the transmitted signal (and thus to avoid degraded performance), the power of the transmitted signal must be below a maximum value (typically 43 dBm) above which the power amplifier is no longer linear (i.e. above which the amplifier distorts the signal). The power is therefore limited to a maximum value for each antenna separately.

Consequently, if all the no-diversity mobile stations are assigned to the no-diversity antenna, the maximum power value for that antenna will be reached sooner than for the diversity antenna, and this will limit the capacity of the system sooner (because, when the maximum power value is reached, no further users may be accepted in the cell).

The applicant has also observed that the no-diversity mode is no more than a special case of the diversity mode with “n” transmit antennas (where 1≦n<N and N is the total number of transmit antennas provided), this special case corresponding to a value of 1 for “n” (n=1). Similarly, if the same cell could contain diversity mode mobile stations with “n” antennas and diversity mode mobile stations with N antennas, if all the diversity mode mobile stations with “n” transmit antennas were assigned to the “n” antennas, the maximum power value of those “n” antennas would be reached sooner than that of the other antennas, which would limit the capacity of the system sooner.

A particular object of the present invention is to avoid these problems.

A more general object of the present invention is to improve the performance of the above systems. In particular, the present invention significantly increases the capacity of the above systems without introducing any complex or costly additional functions.

One aspect of the invention is a method of improving the performance of a mobile radio system with N transmit antennas (where N>1) in which different transmit antenna diversity modes are possible, including at least one mode with “n” transmit antennas (where 1≦n<N), said method comprising a step of selecting “n” transmit antennas from the N transmit antennas for transmission in a mode with “n” transmit antennas.

According to another feature, the method comprises a step in which the network selects “n” transmit antennas from the N transmit antennas (where 1≦n<N) for the transmission to a mobile station in a mode with “n” transmit antennas.

According to another feature, the method further comprises a step in which the network signals to a mobile station the “n” transmit antennas selected from the N transmit antennas (where 1≦n<N) for the transmission to that mobile station in a mode with “n” transmit antennas.

According to another feature, said “n” transmit antennas are selected from the N transmit antennas (where 1≦n<N) in such a manner as to distribute the transmitted powers optimally between the various transmit antennas.

According to another feature, a common pilot channel being associated with each transmit antenna, said method further comprises a step in which a mobile station selects the common pilot channel associated with a selected transmit antenna as signaled by the network.

According to another feature, said selection corresponds to the selection of one of N transmit antennas for the transmission in a no-diversity mode.

Another aspect of the invention is a base station for a mobile radio system with N transmit antennas (where N>1) in which different transmit antenna diversity modes are possible, including at least one mode with “n” transmit antennas (where 1≦n<N), said base station comprising means for selecting “n” transmit antennas from the N transmit antennas for transmission to a mobile station in a mode with “n” transmit antennas.

According to another feature, the base station comprises means for selecting “n” transmit antennas from the N transmit antennas (where 1≦n<N) in such a manner as to distribute the transmitted powers optimally between the various transmit antennas.

According to another feature, the base station further comprises means for signaling to the mobile station “n” transmit antennas from the N transmit antennas selected in the above way (where 1≦n<N).

According to another feature, the base station further comprises means for signaling to a base station controller “n” transmit antennas from the N transmit antennas (where 1≦n<N) selected in the above way.

According to another feature, said selection corresponds to the selection of one of N transmit antennas for the transmission in a no-diversity mode.

Another aspect of the invention is a base station controller for a mobile radio system with N transmit antennas (where N>1) in which different transmit antenna diversity modes are possible, including at least one mode with “n” transmit antennas (where 1≦n<N), said base station controller comprising:
means for receiving from a base station information relating to “n” transmit antennas selected from the N transmit antennas by that base station for the transmission to a mobile station in a mode with “n” transmit antennas, and
means for signaling to the mobile station “n” transmit antennas selected from N in the above way.

Another aspect of the invention is a base station controller for a mobile radio system with N transmit antennas (where N>1) in which different transmit antenna diversity modes are possible, including at least one mode with “n” transmit antennas (where 1≦n<N), said base station controller comprising means for selecting “n” transmit antennas from the N transmit antennas for the transmission to a mobile station in a mode with “n” transmit antennas.

According to another feature, the base station controller comprises means for selecting “n” transmit antennas from the N transmit antennas (where 1≦n<N) in such a manner as to distribute the transmitted powers optimally between the various transmit antennas.

According to another feature, the base station controller further comprises means for signaling to the mobile station the “n” transmit antennas selected in the above way.

According to another feature, said selection corresponds to the selection of one of N transmit antennas for transmission in a no-diversity mode.

Another aspect of the invention is a mobile station for a mobile radio system with N transmit antennas (where N>1) in which different transmit antenna diversity modes are possible, including at least one mode with “n” transmit antennas (where 1≦n<N), said mobile station comprising means for receiving from the network information relating to “n” transmit antennas selected from the N transmit antennas (where 1≦n<N) for transmission to that mobile station in a mode with “n” transmit antennas.

According to another feature, the mobile station further comprises means for selecting a common pilot channel associated with a selected transmit antenna as signaled by the network.

According to another feature, said selection corresponds to the selection of one of N transmit antennas for the transmission in a no-diversity mode.

Another aspect of the present invention is a mobile radio system comprising at least one base station as defined hereinabove and/or at least one base station controller as defined hereinabove and/or at least one mobile station as defined hereinabove.

Other objects and features of the present invention will become apparent in the light of the following description of embodiments of the invention given with reference to the appended drawings, in which:

FIG. 1 summarizes the general architecture of a mobile radio system such as the UMTS in particular,

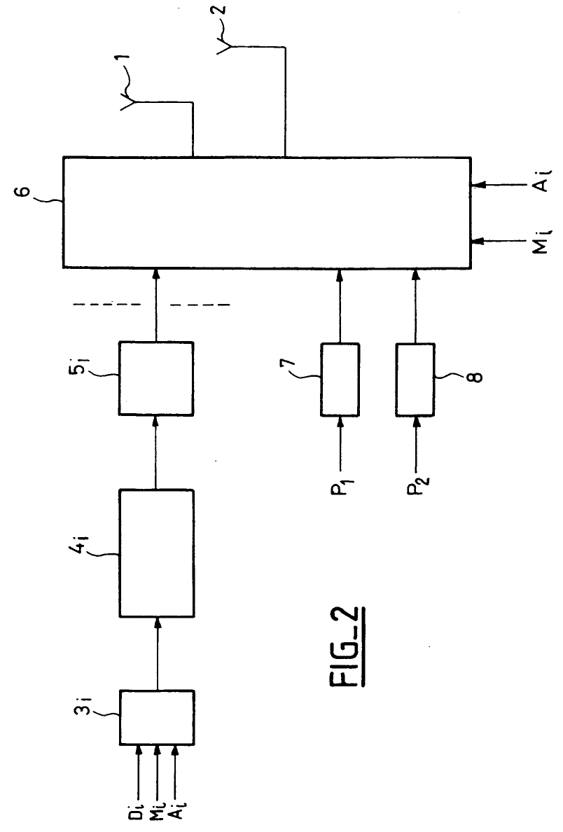

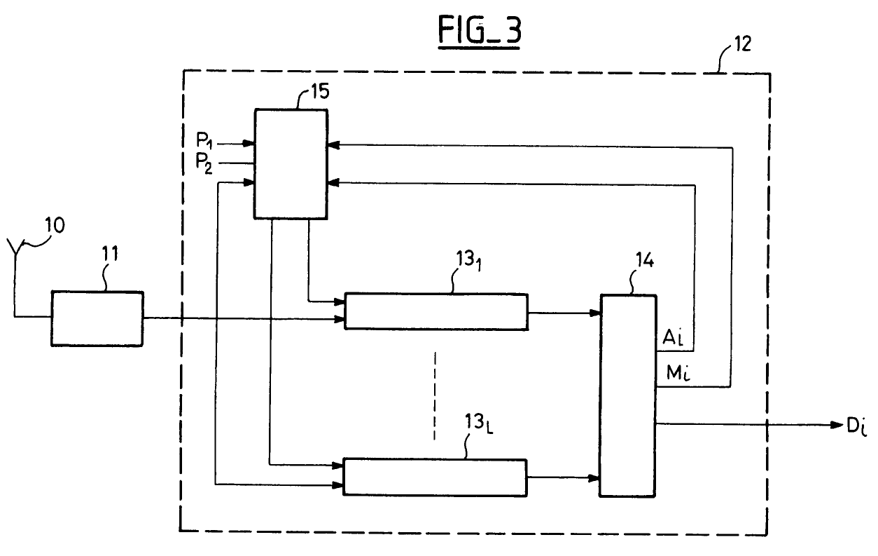

FIGS. 2 and 3 show examples of transmit and receive means, respectively, to be provided for implementing the present invention in the downlink direction in this kind of system,

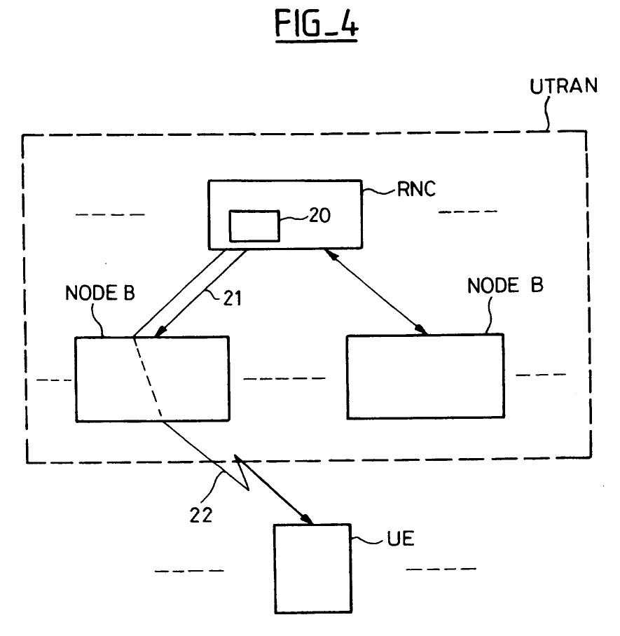

FIG. 4 shows a first embodiment of the invention in this kind of system,

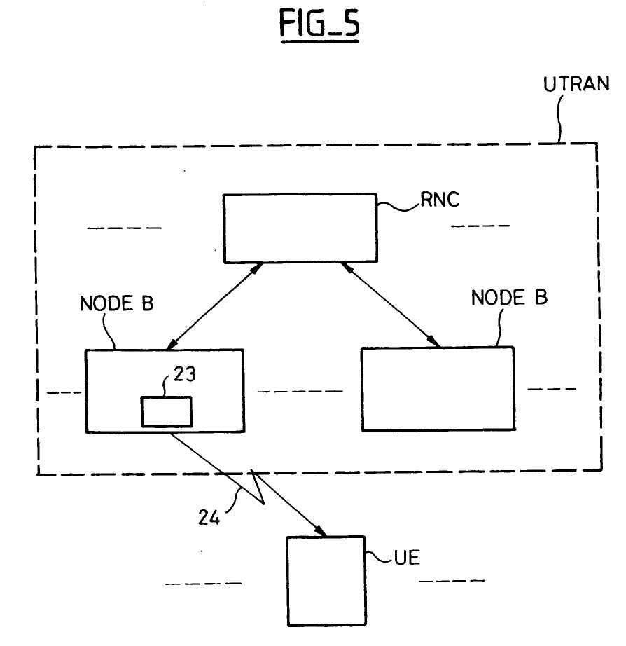

FIG. 5 shows a second embodiment of the invention in this kind of system,

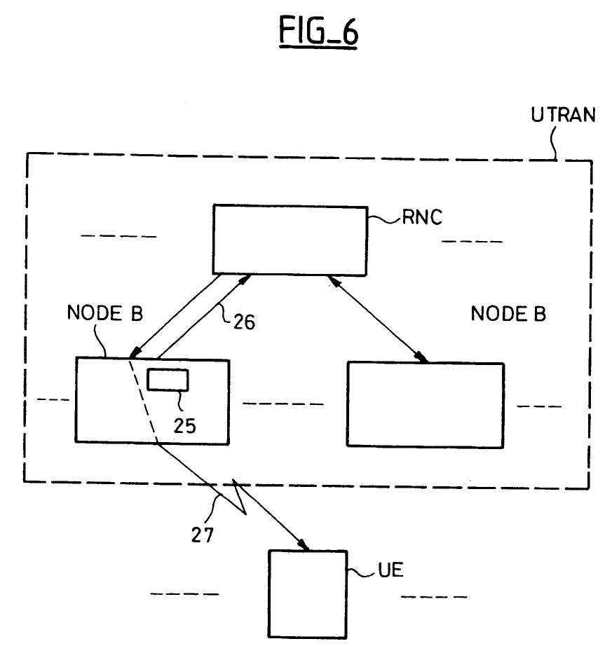

FIG. 6 shows a third embodiment of the invention in this kind of system.

Thus one objective of the present invention is to improve the performance of systems of the above kind with N transmit antennas (where N>1) in which different transmit antenna diversity modes are possible, including a mode with “n” transmit antennas (where 1≦n<N).

The following description considers more particularly and by way of example the situation where N=2 and n=1, corresponding to a system with two transmit antennas and providing a no-diversity mode, thus corresponding in particular to the downlink in a system such as the UMTS.

Generally speaking, the invention provides for any transmit antenna to be used in the no-diversity mode.

For example, in the situation previously referred to of two transmit antennas, either the diversity antenna or the no-diversity antenna may be used in the no-diversity mode.

For example, in a cell with 40 mobile stations using the same service and the no-diversity mode, the no-diversity antenna would be used for 20 of the mobile stations and the diversity antenna would be used for 20 other mobile stations. This distribution of the mobile stations between the various transmit antennas could be different in the case of mobile stations not using the same service (because these mobile stations would not necessitate the same transmit power), although it is nevertheless clear that the basic idea remains unchanged.

As a general rule, it may be noted that the type of situation at which the present invention is directed (namely a situation in which certain mobile stations use the diversity mode while other mobile stations use the no-diversity mode) may arise for different reasons, for example:
certain mobile stations could support none of the diversity modes (although this reason is highly unlikely in a system like the UMTS, in which mobile stations must support all the transmit diversity modes specified by the standard),
in certain cases, performance may be better in the no-diversity mode than in a diversity mode; thus the closed loop diversity mode generally yields worse performance than the no-diversity mode if the mobile station is moving at high speed or if the mobile station is in a soft handover configuration; the network could then deactivate the diversity mode for mobile stations in this situation and activate it for other mobile stations, and
certain mobile stations may be in a soft handover (macrodiversity) configuration with at least one base station that does not support transmit antenna diversity; in this case, there may be provision for these mobile stations not to use transmit antenna diversity, whereas mobile stations that are connected only to base stations that support transmit antenna diversity could use it.

In contrast to the prior art techniques referred to above, the invention therefore makes no provision for always using the same transmit antenna (for example, in the situation referred to above of two transmit antennas, the no-diversity antenna) for transmission in the transmit antenna no-diversity mode.

In other words, in contrast to the prior art techniques referred to above, the invention provides for the use of a step of selecting a transmit antenna for transmission in the transmit antenna no-diversity mode.

As a general rule, a transmit antenna may be selected independently for each channel to be transmitted in the no-diversity mode.

The term “channel” is used here to designate resources assigned for the transmission of information so that a transmit antenna may be selected independently for each channel to be transmitted. This term may therefore have the same meaning that it usually has in these systems. In particular, in the application of the invention to the UMTS, this may refer to the dedicated physical channel (DPCH) as defined in the UMTS specifications.

In the downlink direction, this kind of selection may thus be effected independently for each mobile station to which one or more channels are to be transmitted in the no-diversity mode (such as in particular DPCH(s) in the UMTS).

Thus, in the downlink direction, the invention provides for using a step in which the network selects a transmit antenna for transmission to a mobile station in the transmit antenna no-diversity mode.

Another step may be provided in which the network signals to a mobile station the transmit antenna that has been selected for transmission to that mobile station in the transmit antenna no-diversity mode.

Said transmit antenna selection is advantageously effected in such a manner as to distribute optimally the powers transmitted at the various transmit antennas.

In the example of the UMTS considered here, under the current standard, a no-diversity mode mobile station assumes that the dedicated channel(s) (DPCH(s)) transmitted to it are transmitted at a predetermined one of the two antennas, called the no-diversity antenna, and the mobile station then estimates the radio channel from the P-CPICH transmitted at that antenna.

However, if the downlink channel(s) DPCH(s) were transmitted at the diversity antenna, the radio channel would have to be estimated on the basis of the P-CPICH transmitted at the diversity antenna.

In this case, to enable either of these two antennas (the diversity antenna and the no-diversity antenna) to be used, in accordance with the present invention, in the no-diversity mode, the mobile station is informed of the transmit antenna used by the Node B, so as to be able to effect any processing on the corresponding P-CPICH (such as radio channel estimation in particular). It will be noted that in a system such as the UMTS in particular, processing such as radio channel estimation could also be based on the secondary-common pilot channel (S-CPICH).

Indicating the transmit antenna or antennas used for a given mobile station is intended to enable that mobile station to effect any processing that presupposes a knowledge of the transmit antenna used. This includes the processing effected by the P-CPICH or the S-CPICH, as these two channels transmit bits known to the receiver, given that the sequence of bits transmitted depends on the transmit antenna.

In other words, a common pilot channel being associated with each transmit antenna, the invention further provides a step in which a mobile station selects the common pilot channel associated with the transmit antenna indicated by the network. Various possibilities are generally available of associating a common pilot channel with a transmit antenna. For example, a common pilot channel may use particular transmission resources associated with a transmit antenna. Alternatively, if the same resources are assigned for the transmission of that channel by the various antennas, a common pilot channel may transport particular information (or a particular sequence of bits) associated with a transmit antenna (this latter possibility corresponds more particularly to the UMTS, as indicated above).

FIGS. 2 and 3 show examples of transmit and receive means, respectively, to be provided for implementing the invention in the downlink direction, from the network to the mobile stations. It will be noted that these figures represent such means only in a highly diagrammatic form, and only to the degree necessary for understanding the present invention, without going into the details of the communication methods or protocols used in these systems or into the details of how functions are distributed between the component entities of such systems.

In the FIG. 2 example, relating more particularly to the UMTS, there are two transmit antennas 1 and 2. Of course, the invention is not limited to this example.

The FIG. 2 diagram comprises, for each mobile station UEi to which the network may transmit data:
means 3i for formatting the information to be transmitted to the mobile station in a format appropriate for its transmission,
transmit processing means 4i for effecting processing including in particular channel coding, interleaving, bit rate adaptation, etc, and
spreading means 5i for receiving at least one spreading code corresponding to at least one dedicated physical channel assigned to the mobile station concerned.

The information to be transmitted to the mobile station UEi includes in particular:
payload data Di to be transmitted to the mobile station,
the diversity mode Mi selected for the mobile station, and
the transmit antenna Ai selected for the mobile station, when the diversity mode selected is the no-diversity mode.

The FIG. 2 diagram further comprises radio transmitter means 6 for generating, from the various signals coming from the various spreading means like the means 5i corresponding to different mobile stations UEi, radio signals to be applied to one and/or the other of the various transmit antennas in accordance with the diversity mode Mi selected for each mobile station UEi and according to the transmit antenna Ai selected for each mobile station UEi in the case of the no-diversity mode.

The FIG. 2 diagram further comprises spreading means 7 and 8 receiving a spreading code assigned for the transmission of a common pilot channel at each antenna (the respective bit patterns P1 and P2 transmitted on this common pilot channel for each antenna being different). The resulting signals are also applied to the radio transmitter means 6, which generate corresponding radio signals to be applied to the transmit antennas.

In the FIG. 2 example, the information Ai relating to the transmit antenna selected for a mobile station UEi in the no-diversity mode is used by the radio transmitter means 6 to apply the corresponding radio signals to the selected transmit antenna, as explained above. In the FIG. 2 example, the information Ai is also signaled to the mobile station to enable it to select a pilot channel associated with the selected transmit antenna (also as explained above).

The other functions of the FIG. 2 diagram are well known to the person skilled in the art and therefore do not need to be described again here in more detail.

The FIG. 3 diagram comprises:
radio receiver means 11 connected to a receive antenna 10, and
received data estimating means 12.

The processing carried out in the means 12 corresponds in this example to that carried out in a Rake receiver. A Rake receiver comprises a set of L fingers 13₁ to 13_{L} and means 14 for combining the signals from the various fingers. Each finger despreads the signal received on one of the paths, which are determined by radio channel impulse response estimation means 15. The means 14 combine the despread signals corresponding to the various paths by processing them in a manner that is intended to optimize the quality of the estimate of the received data Di.

The radio channel impulse response estimation means 15 determine the impulse response of one and/or the other of the radio channels connecting each of the transmit antennas to the receive antenna according to the transmit diversity mode Mi selected for the mobile station UEi concerned and according to the transmit antenna Ai selected in the case of the no-diversity mode. The selected diversity mode Mi and the selected transmit antenna Ai are signaled to the mobile station by the network and reconstituted in the receiver by the means 14. The information Ai is used by the mobile station (in the means 15 in the FIG. 3 example) to select a common pilot channel corresponding to the selected transmit antenna Ai in the case of the no-diversity mode, in particular to estimate the corresponding radio channel, as explained above.

The other functions of the FIG. 3 example are well known to the person skilled in the art and therefore do not need to be described again here in more detail.

Various embodiments of the invention used in a system of the above kind are described next.

In a first example, which may constitute a preferred embodiment, the transmit antenna allocated in the no-diversity mode is selected by the RNC, as indicated at 20 in FIG. 4, and signaled both to the UE and to the Node B, as shown at 21 and 22, respectively, in FIG. 4.

Signaling sent from the RNC to the UE advantageously uses a signaling message of the radio resource control (RRC) protocol used for communication between the RNC and the UE. Signaling sent from the RNC to the Node B advantageously uses a signaling message of the Node B application part (NBAP) protocol used for communication between the RNC and the node B.

For example, the assigned transmit antenna may be signaled by adding an information element (IE) having two possible values (each corresponding to one of the transmit antennas) to some or all of the existing messages for fixing or changing the transmit diversity mode (i.e. the messages that contain the diversity mode IE).

For the Node B application part (NBAP) protocol as defined in the technical specification 3G TS 25.433, the main messages are:
Radio Link Setup Request,
Radio Link Reconfiguration Prepare.

More generally, a message may be any message enabling an equipment such as a base station controller having a radio resource control function to signal, to a base station that it controls, any change in the reservation of radio resources in the base station, in particular because of the setting up or reconfiguration of a radio link between that base station and a mobile station.

For the radio resource control (RRC) protocol, as defined in the technical specification 3G TS 25.331, this means in particular the messages:
Active Set Update,
Cell Update Confirm,
Handover to UTRAN Command,
Physical Channel Reconfiguration,
Radio Bearer Reconfiguration,
Radio Bearer Release,
RRC Connection Setup,
Transport Channel Reconfiguration.

More generally, the message may be any message enabling an equipment such as a base station controller having a radio resource control function to signal to a mobile station any change in the radio resources assigned to that mobile station, in particular for the following reasons:
these systems generally have a cellular architecture and mechanisms are provided for continuously selecting a best server cell and/or a best server network, such as in particular handover mechanisms and cell selection or reselection mechanisms, the best cell being chosen by the mobile stations and/or by the network, depending on the mechanisms concerned; also, these systems generally use the soft handover technique whereby a mobile station may be connected simultaneously to a plurality of base stations, all of the base stations to which the mobile station is connected being referred to as the active set, and
in these systems, the radio resources are generally assigned flexibly to users as a function of the services required and as a function of diverse other factors such as the radio and/or traffic conditions encountered in particular; also, these systems generally have a layered organization that leads to distinguishing between possible different levels of assigning radio resources for the various connection set-up, reconfiguration or release operations (for example, in the UMTS, distinguishing physical channels, transport channels and radio bearers).

In a second example, the transmit antenna assigned in the no-diversity mode is selected by the Node B, as shown at 23 in FIG. 5, and signaled to the UE, as shown at 24 in FIG. 5.

Signaling from the node B to the UE then uses the corresponding protocol for communication between the Node B and the UE or layer 1 protocol (which is more costly in terms of signaling).

In a third example, the transmit antenna assigned in the no-diversity mode is selected by the Node B, as shown at 25 in FIG. 6, then signaled to the RNC, as shown at 26 in FIG. 6, and then signaled by the RNC to the UE, as shown at 27 in FIG. 6.

Signaling from the Node B to the RNC may use a signaling message of the corresponding protocol for communication between the Node B and the RNC, which is the Node B application part (NBAP) protocol. Signaling from the RNC to the UE may use a signaling message of the corresponding protocol for communication between the RNC and the UE, which is the radio resource control (RRC) protocol.

In this case, the procedure could be as follows: if the RNC indicates in a message to the Node B the diversity mode used for a certain radio link, then the Node B indicates to the RNC which transmit antenna is selected in the response message to the RNC. In particular, for the NBAP protocol, this message from the Node B to the RNC may be one of the following messages:
Radio Link Setup Response,
Radio Link Reconfiguration Ready.

In the first or third example, the RNC knows the various calls set up via a Node B that it controls and the services required for those various calls. The RNC may also know certain parameters characteristic of the power amplifier associated with each transmit antenna of the Node B, such as the maximum transmit power of that amplifier in particular (where applicable, the Node B may signal to the RNC information relating to characteristic parameters of this kind, as such information may be more readily obtained from the Node B). The RNC may therefore select a transmit antenna for each UE in a manner that avoids the drawbacks mentioned above, i.e. in a manner that distributes the transmitted power optimally between the transmit antennas, or in a manner that avoids a maximum transmit power being reached sooner for one transmit antenna than for another.

In the second example, the Node B may also select a transmit antenna for each UE in such a manner as to avoid the drawbacks mentioned above, i.e. to distribute the transmitted power optimally between the transmit antennas, or in such a manner as to avoid that a maximum transmit power is reached sooner for one transmit antenna than for another.

Although the above description relates by way of more particular example to the situation in which N=2 and n=1 (corresponding to a system with two transmit antennas in which a no-diversity mode is provided), the invention is not limited to this kind of example.

The above description may in particular be generalized to the situation in which N>2 and n=1 (corresponding to a system with N transmit antennas in which a no-diversity mode is provided). According to the principles described above, the network may signal to a mobile station which of the N transmit antennas has been selected for transmission to that mobile station in the no-diversity mode. The mobile station may also select a common pilot channel associated with a selected transmit antenna as signaled by the network.

The above description may also be generalized to the situation in which N>n and n>1 (corresponding to a system with N transmit antennas in which a diversity mode with “n” transmit antennas is provided). According to the principles described above, the network may therefore signal to a mobile station which “n” transmit antennas have been selected from the N antennas for transmission to that mobile station in a mode with “n” transmit antennas. Thus in the situation where N>2 and n=2, for example, the network may signal to a mobile station the two transmit antennas selected from the N antennas for transmission to that mobile station in a diversity mode with two transmit antennas. The mobile station may also select a common pilot channel associated with a selected transmit antenna and signaled by the network. As a general rule, the type of situation targeted by the present invention (i.e. a situation in which certain mobile stations use a diversity mode with “n” antennas whereas other mobile stations use a diversity mode with N antennas) may arise for different reasons, for example:
certain mobile stations might not support a diversity mode with N antennas, but support only a diversity mode with “n” antennas,
in certain cases, performance may be better in a diversity mode with “n” antennas than in a diversity mode with N antennas,
certain mobile stations may be in a soft handover configuration with at least one base station that does not support diversity with N transmit antennas but only diversity with “n” transmit antennas; in this case, these mobile stations could not use diversity with N transmit antennas, whereas the mobile stations that are connected only to base stations that support diversity with N antennas transmit could use it.

1. Method of improving the performance of a mobile radio system with N transmit antennas (where N>1) in which different transmit antenna diversity modes are possible, including at least one mode with “n” transmit antennas (where 1≦n<N), said method comprising a step of selecting “n” transmit antennas from the N transmit antennas for transmission in a mode with “n” transmit antennas.

2. Method according to claim 1, comprising a step in which the network selects “n” transmit antennas from the N transmit antennas (where 1≦n<N) for the transmission to a mobile station in a mode with “n” transmit antennas.

3. Method according to claim 2, further comprising a step in which the network signals to a mobile station the “n” transmit antennas selected from the N transmit antennas (where 1≦n<N) for the transmission to that mobile station in a mode with “n” transmit antennas.

4. Method according to claim 1, wherein said “n” transmit antennas are selected from the N transmit antennas (where 1≦n<N) in such a manner as to distribute the transmitted powers optimally between the various transmit antennas.

5. Method according to claim 2, wherein, a common pilot channel being associated with each transmit antenna, said method further comprises a step in which a mobile station selects a common pilot channel associated with a selected transmit antenna as signaled by the network.

6. Method according to claim 1, wherein said selection corresponds to the selection of one of N transmit antennas for the transmission in a no-diversity mode.

7. Base station for a mobile radio system with N transmit antennas (where N>1) in which different transmit antenna diversity modes are possible, including at least one mode with “n” transmit antennas (where 1≦n<N), said base station comprising means for selecting “n” transmit antennas from the N transmit antennas for transmission to a mobile station in a mode with “n” transmit antennas.

8. Base station according to claim 7, comprising means for selecting “n” transmit antennas from the N transmit antennas (where 1≦n<N) in such a manner as to distribute the transmitted powers optimally between the various transmit antennas.

9. Base station according to either claim 7, further comprising means for signaling to the mobile station “n” transmit antennas from the N transmit antennas selected in the above way (where 1≦n<N).

10. Base station according to either claim 7, further comprising means for signaling to a base station controller “n” transmit antennas from the N transmit antennas (where 1≦n<N) selected in the above way.

11. Base station according to claim 7, wherein said selection corresponds to the selection of one of N transmit antennas for the transmission in a no-diversity mode.

12. Base station controller for a mobile radio system with N transmit antennas (where N>1) in which different transmit antenna diversity modes are possible, including at least one mode with “n” transmit antennas (where 1≦n<N), said base station controller comprising:
means for receiving from a base station information relating to “n” transmit antennas selected from the N transmit antennas (where 1≦n<N) by that base station for the transmission to a mobile station in a mode with “n” transmit antennas, and
means for signaling to the mobile station n transmit antennas selected in the above way.

13. Base station controller for a mobile radio system with N transmit antennas (where N>1) in which different transmit antenna diversity modes are possible, including at least one mode with “n” transmit antennas (where 1≦n<N), said base station controller comprising means for selecting “n” transmit antennas from the N transmit antennas (where 1≦n<N) for the transmission to a mobile station in a mode with “n” transmit antennas.

14. Base station controller according to claim 13, comprising means for selecting “n” transmit antennas from the N transmit antennas (where 1≦n<N) in such a manner as to distribute the transmitted powers optimally between the various transmit antennas.

15. Base station controller according to claim 13, further comprising means for signaling to the mobile station the n transmit antennas selected in the above way from the N transmit antennas (where 1≦n<N).

16. Base station controller according to claim 12, wherein said selection corresponds to the selection of one of N transmit antennas for transmission in a no-diversity mode.

17. Mobile station for a mobile radio system with N transmit antennas (where N>1) in which different transmit antenna diversity modes are possible, including at least one mode with “n” transmit antennas (where 1≦n<N), said mobile station comprising means for receiving from the network information relating to “n” transmit antennas selected from the N transmit antennas (where 1≦n<N) for transmission to that mobile station in a mode with “n” transmit antennas.

18. Mobile station according to claim 17, further comprising means for selecting a common pilot channel associated with a selected transmit antenna as signaled by the network.

19. Mobile station according to claim 17, wherein said selection corresponds to the selection of one of N transmit antennas for the transmission in a no-diversity mode.

20. Mobile radio system comprising at least one base station according to claim 7.

21. Mobile radio system comprising at least one base station controller according to claim 12.

22. Mobile radio system comprising at least one mobile station according to claim 17.
